(19) United States
(12) Patent Application Publication
(10) Pub. No.: US 2009/0029611 A1
(43) Pub. Date: Jan. 29, 2009

(54) MULTIFUNCTION SAFETY GARMENT

(76) Inventors: Ross Spencer, New South Wales (AU); Karl Price, Tas (AU)

Correspondence Address: STITES & HARBISON PLLC, 1199 NORTH FAIRFAX STREET, SUITE 900, ALEXANDRIA, VA, 22314, US

(21) Appl. No.: 11/722,596

(22) PCT Filed: Dec. 24, 2005
(86) PCT No.: PCT/AU05/01969

§ 371 Date: Sep. 2, 2008

(30) Foreign Application Priority Data
Dec. 24, 2004 (AU) 2004907321

(51) Int. Cl. B63C 9/08; A41D 13/012; A41D 1/04; A62B 1/16

(52) U.S. Cl. 441/114; 2/455; 2/102; 182/3; 441/106

(57) ABSTRACT

A safety garment comprising; a garment body arranged for location on a torso of a wearer. The garment body includes openings to accommodate a wearers neck and arms and means for securing the garment to the torso of a wearer. The vest includes a space on the garment which receives and retains weights and a buoyancy apparatus providing means to allow a wearer to select a required amount of buoyancy. The vest also includes a harnessing assembly to allow attachment of the safety garment to a load line, the harnessing assembly allowing a user to be winched to safety allowing the garment to support the weight of a person wearing the garment.

### BACKGROUND

The present invention relates to the field of human safety and personal protection devices, and more particularly to safety garments, jackets and the like which offer protection for a wearer's body. The present invention further relates to improvements in safety garments and more particularly relates to a multi function safety garment suitable for use is high risk activities such as but not limited to sea and land rescues, and particularly in circumstances when a rescuer must be harnessed to a safety line umbilical cord or the like. The invention further provides a multi function safety garment which includes all in one a buoyancy apparatus, safety harness assembly and weight belt.

### PRIOR ART

There are in existence a plurality of safety garments for the protection of the human body. Such known devices include as a separate item a buoyancy vest, a weight belt and garments which include hitches to receive and retain a safety line for haulage of a person or victim into an aircraft such as a helicopter.

In the past, the aforesaid apparatuses have been provided as separate items or items incorporated in a wear garment. For instance, a weight belt has traditionally been provided as a belt which is fitted as a belt strap having lead weights attached. There are also available neck and shoulder mounted buoyancy vests which are used in marine applications including diving and for rescue operations. The prior art also provides a garment which provides integral means to allow harness lines to be attached for hoisting a person to safety in rescue operations. The equipment used in marine and safety operations generally has been available in various forms for some time but to date the equipment has been provided on separate products. Items such as protective padded garments have been provided with built in flotation and also to offer protection to a body part from blows, falls, and other sources of impact trauma. Also known are inflatable vests used as life preservers, i.e., to provide added buoyancy to keep the human body afloat in water. Inflatable life vests of conventional design typically include a bladder defining one or more envelopes which are connected to a source of pressurized gas. The gas is applied via a gas source such as a cartridge. The cartridge may be actuated manually, by pulling an actuation cord connected to a valve-actuation pin that opens a valve connecting the cartridge to a gas inlet tube communicating with the bladder. Other safety vests are provided which spontaneously inflate while a person is engaging in a hazardous or semi-hazardous activity. There are also in existence inflatable protective garments that can be worn comfortably in a deflated condition, either alone or with a further jacket, and that can be automatically inflated. Some known vests include a compressed gas cartridge communicating with the interior of a bladder through an inflation tube that is held within the vest. The prior art also teaches various safety garments examples of which are identified below.

U.S. Pat. No. 6,062,929 discloses a vest-like flotation garment including a buoyant work vest and a flotation unit attached to the work vest in order to enhance the buoyancy of the work vest. The work vest includes a wear-resistant surface layer and an inner lining, between which is arranged at least one elastic and shape-permanent flotation body. The flotation unit includes one or more flotation members arranged on the front part of the work vest and extending around its neck section. The flotation unit is detachably fixed to the work vest with the aid of a first fastening device, one member of which is arranged at the neck section of the work vest and the other member of which is arranged at the neck section of the flotation unit, and a second fastening device, one member of which is arranged on a portion of the flotation member spaced from the neck section and the other member of which is arranged on the front part of the work vest.

U.S. Pat. No. 5,641,247 discloses a combination spider and buoyancy compensator having an insertable weight system. The spider includes an insertable weight system disposed preferably within at least one side opening pocket attached to a waistband portion. The side opening pocket can be formed of a piece of material attached to a waistband portion to define a channel in the space between the waistband portion and the piece of material. At least one weight disposed within an envelope, preferably having stiffening material, is removably inserted within the pocket. The envelope containing the weight includes means, preferably including areas of brushed material and hooks, and a handle for inserting, securing, and removably releasing the envelope containing the weight within the pocket.

U.S. Pat. No. 5,662,433 discloses a combination spider and buoyancy compensator having chest portions which include stretchable material to support the breasts of a diver. The buoyancy compensator is secured to the back of a spider and has forward extensions which overlap and are loosely tethered to waistband portions of the spider. The waistband portions of the spider are secured to the back portion of the spider by adjustable means for waist size adjustment.

U.S. Pat. No. 6,527,479 discloses a break away counterweight with neutralizing buoyancy offset for diver's safety. The patent discloses a water safety and survival system that provides a multi-chambered personal flotation device and break away counterweight that provides a heads-up righting moment that reliably positions a scuba diver's airway out of the water when at the surface, and provides for a comfortable heads down position during the dive. The break away counterweight stows the ballast needed to heel the diver into a heads up position in an inactive state. Once released, the counterweight drops away and becomes capable of actively rolling the diver's face out of the water into the heads up position. The counterweight is preferably utilized in conjunction with a buoyancy compensator that further provides for rotation of the diver into a heads up orientation, and that can provide buoyancy compensation for the counterweight.

U.S. Pat. No. 4,690,314 discloses a buoyancy compensator insertable backpack in the form of a configured insert having an inverted T conformation. The inverted T conformation has an upright portion with ribs which provide rigidity to the upright and includes at least one set of slits therethrough in order to secure a breathing gas tank by a metal band passing therethrough and around the tank. The lower or transverse portion of the inverted T shaped backpack is curved to follow the contour of a person's torso so that support can be provided to the upright portion by having a load distributed across a person's torso in the pelvis, small area of the back, or hip area. The entire insertable backpack is adapted with a buoyancy compensator so as to provide for support of a breathing gas tank on the backpack within the buoyancy compensator, all of which are secured on a user's body for providing buoyancy compensation and attendant support of a breathing gas tank.

U.S. Pat. No. 5,346,419 discloses a buoyancy compensator device with backpack and an adjustable harness having a pair of tank encircling straps for connection of the backpack to a compressed air tank, inflation hoses for receiving air from a tank and inflating the buoyancy compensator device and valves for releasing air from the buoyancy compensator including selectively operational valves and automatic over-inflation air releasing valves. The buoyancy compensator includes a backpack portion for supporting the tank and a harness system for attaching the backpack and buoyancy compensator to a wearer. The harness system includes adjustable shoulder straps and adjustable waist straps including a cumber bun for comfortably securing the buoyancy compensator around a wearer's torso.

U.S. Pat. NO. 4,167,051 discloses a buoyant life jacket which embodies a pair of front and side sections, each of which includes a series of articulated fabric-covered buoyant panels, and a rear section which is composed of a lightweight open-mesh fabric which is connected to the front and side sections at the rear of the latter. A slide fastener interconnects the two front and side sections at the center thereof and extends from the neck opening at the top to the bottom of the life jacket at the front thereof. Securing means in the form of a pair of flexible cloth fastening straps and buckles are arranged at the bottom of the rear and open-mesh fabric section for securing the buoyant life jacket in position of use on the body of the wearer.

U.S. Pat. NO. 4,917,641 discloses a lined life-jacket comprising an airtight inflatable bag extending along the front and along the area of the neck and shoulders. The jacket includes a device for supplying compressed air into the airtight bag and an inflation tube. The compressed air supply device and the inflation tube are so arranged on the life-jacket that a person wearing the life-jacket can easily operate the device by hand and easily place the tube in the wearer's mouth.

U.S. Pat. No. 5,494,469 discloses an inflatable life vest comprises two sheets of polymeric material. The sheets are sealed to form an inner cavity with a plurality of discrete, inflatable chambers disposed in a U-shaped pattern to define collar and chest portions of the life vest. A manifold connects to an inflation source and has a plurality of openings. A check valve connects each manifold opening with one of the chambers to permit inflation medium flow into the chamber and to block inflation medium flow outwardly from a chamber into the manifold.

It may be seen from the above prior art devices that there are a large variety of safety devices each having features for a specific purpose related to safety and survival. Each has features or a form of construction which provide one or two services such as life support-buoyancy/floatation and a harness.

All of these proposals are intended to fulfill the market's need upon considering the criteria of use. Safety vests are normally designed according to the objectives and environment of use required and largely differ in the configuration of the safety features as they are located on the jacket or vest.

The prior art does not teach a three in one garment which can be worn by a user such as in a rescue operation and which provides the facilities of weighting, buoyancy and harnessing. There is a long felt want to provide an improved safety harness having integrally attached to the garment the primary facilities which are often required in a typical rescue operation, such as buoyancy, harnessing and weighting. There is also a need to provide an all in one safety and life support garment which is configured with features which optimise wearer comfort.

### INVENTION

The present invention provides improvement in the manufacture and design of safety garments so as to offer safety features which are required in a typical rescue operation. The present invention further provides improvements in such garments which result in the garment having unique construction.

The present invention according to one embodiment, provides a safety garment including weighting, buoyancy and harnessing assemblies built into the garment to obviate the need to use separate products to provide the same attributes and combination of facilities.

The invention further provides a garment having an integrally attached a buoyancy vest weight belt and harnessing assembly for use in but not limited to such operations as marine rescue and salvage.

It is one object of the present invention to provide an alternative to the known safety and rescue equipment by providing a garment which has multi functional facilities.

In one broad form the present invention comprises:
a safety garment comprising;
a garment body arranged for location on a torso of a wearer; the garment body including openings to accommodate a wearers neck and arms;
the safety garment further comprising;
means for securing the garment to the body of a wearer;
an internal space which receives and retains weights therein;
a buoyancy apparatus providing means to allow a wearer to select a required amount of buoyancy;
a harnessing assembly to allow attachment of said garment to a load line; the harnessing assembly allowing the garment to support the weight of a person wearing the garment.

According to one embodiment, the internal space in which the weights are located is disposed in a bottom region of the garment which approximates the waist of a wearer.

In another broad form the present invention comprises:
a vest comprising a combined safety harness, buoyancy apparatus and weighting assembly to form a safety garment, the garment comprising;
a garment body arranged for location on a torso of a wearer; the garment body including openings to accommodate a wearers neck and arms;
means for securing the garment to the body of a wearer;
an internal space which receives and retains weights of the weighting assembly therein;
the buoyancy apparatus providing means to allow a wearer to select a required amount of buoyancy;
the safety harness adapted to allow attachment of said garment to a load line; the harnessing assembly allowing the garment to support the weight of a person wearing the garment.

In another broad form the present invention comprises:
a vest comprising a combined safety harness, buoyancy apparatus and weighting assembly to form a safety garment, the garment comprising;
a garment body arranged for location on a torso of a wearer; the garment body including openings to accommodate a wearers neck and arms;
means for securing the garment to the body of a wearer;
an internal space which receives and retains weights of the weighting assembly therein;
the buoyancy apparatus providing means to allow a wearer to select a required amount of buoyancy;
the safety harness adapted to allow attachment of said garment to a load line; the harnessing assembly allowing the garment to support the weight of a person wearing the garment.

In another broad form the present invention comprises:
a vest comprising a combined safety harness, buoyancy apparatus and weighting assembly to form a safety garment, the garment comprising;
a garment body arranged for location on a torso of a wearer; the garment body including openings to accommodate a wearers neck and arms;
means for securing the garment to the body of a wearer;
at least one internal space disposed about the girth of a wearer which receives and retains weights of the weighting assembly therein;
the buoyancy apparatus disposed at a rear of the safety garment and providing means to allow a wearer to select a required amount of buoyancy;
the safety harness adapted to allow attachment of said garment to a load line via attachment means disposed near a shoulder region of the garment; the harnessing assembly allowing the garment to support the weight of a person wearing the garment.

### BRIEF DESCRIPTION OF DRAWINGS

The present invention will be now described according to a preferred but non limiting embodiment and with reference to the accompanying illustrations wherein:

FIG. 1 shows a front elevation view of a safety garment according to one embodiment fitted to a person.

FIG. 2 shows a side elevation view of the safety garment of FIG. 1.

FIG. 3 shows a rear elevation view of the safety garment of FIG. 1

### DETAILED DESCRIPTION OF THE PREFERRED EMBODIMENT

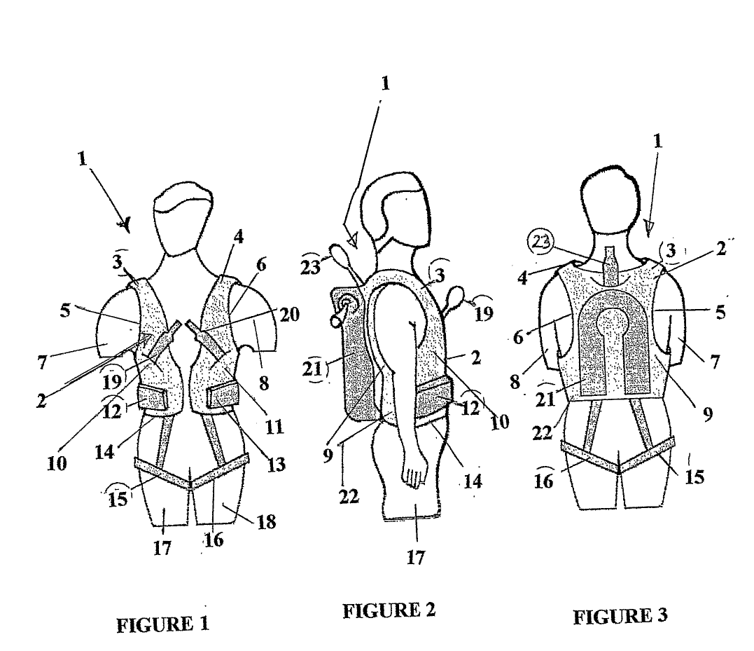

FIGS. 1, 2, and 3 show respectively, front, side and rear views of a safety garment 1, in accordance with a preferred embodiment of the present invention. Garment 1 is capable of wear on the torso of a person as shown and may be secured to the crotch ad thighs of the wearer. The garment 1 comprises a vest body 2 including shoulder straps 3 and 4 which define shoulder openings 5 and 6 to receive arms 7 and 8 of a wearer. Vest body 2 also comprises back region 9 and midriff portions 10 and 11. As shown in FIGS. 1 and 2 midriff portions 10 and 11 receive and retains weight pockets 12 and 13 preferably located at a girth 14 of vest 2. The weight pockets 12 are preferably integrally attached to the vest by such fixation as stitching but these may also be attached by a detachable fixation regime using detachable fasteners. As shown in FIG. 1, vest 2 further comprises downwardly depending skirts 15 and 16 which are secured respectively to a user's thighs 17 and 18. Extending from midriff portions 10 and 11 of vest 2 are harnesses 19 and 20 which allow attachment of vest 2 to a lifting line (not shown) such as may be used in an emergency rescue. FIG. 2 shows a side elevation view of the safety garment of FIG. 1 with corresponding numbering for corresponding parts. Attached to back region 9 of vest 2 is a buoyancy assembly 21. Preferably, buoyancy assembly 21 is attached to shoulder straps 3 and 4 and at lower back region 22.

FIG. 3 shows a rear elevation view of the safety garment of FIG. 1 with corresponding numbering for corresponding parts.

Referring to the FIG. 3 rear view of garment 1 vest body 2 includes shoulder straps 3 and 4 which define openings 5 and 6 to receive arms 7 and 8 of the wearer. Skirts 15 and 16 are secured respectively to a user's thighs 17 and 18 providing bottom anchorage. Extending from vest 2 is harnesses 23 which allows attachment of vest 2 to a lifting line (not shown) such as may be used in an emergency rescue. Harness 23 may be used in conjunction with front mounted harnesses 19 and 20 each disposed to optimise weight distribution during lifting of the wearer. Attached to back region 9 of vest 2 is a buoyancy assembly 21. Preferably, buoyancy assembly 21 is attached to vest 2 via shoulder straps 3 and 4 and at lower back region 22. Buoyancy assembly is inflatable by the user.

The safety garment described above has numerous advantages over the prior art devices. Firstly the garment includes three assemblies in the one garment not previously found in the prior art, namely a buoyancy apparatus, weights pockets and safety lifting harness. Preferably the garment also includes buckles or clips to secure the vest to the body of a user. The vest may further include secondary weight chambers to receive additional weights. Weights may be released at the option of the user by a pull chord which opens the weight chambers to release the weights.

The advantages include additional safety due to the combined assemblies of buoyancy, weight and harnessing in an all in one vest. There is an overall improvement in strength of the vest to accommodate the assemblies. The vest may be constructed from a wear-resistant outer and inner layer with an inner lining. The layers may be constructed from a plastics material.

It will be recognised by persons skilled in the art that numerous variations and modifications may be made to the invention broadly described herein without departing from the overall spirit and scope of the invention.

The claims defining the invention are as follows:

1. A safety garment comprising;
a garment body arranged for location on a torso of a wearer; the garment body including openings to accommodate a wearers neck and arms;
the safety garment further comprising;
means for securing the garment to the torso of a wearer;
a space on the garment which receives and retains weights;
a buoyancy apparatus providing means to allow a wearer to select a required amount of buoyancy;
a harnessing assembly to allow attachment of said garment to a load line; the harnessing assembly allowing the garment to support the weight of a person wearing the garment.

2. A safety garment according to claim 1 wherein the weights are retained in at least one internal space in the garment.

3. A safety garment according to claim 2 wherein, the internal space or spaces in which the weights are located is disposed in a region of the garment which approximates the position of a waist of a wearer.

4. A safety garment according to claim 3 wherein the garment is configured as a sleeveless vest.

5. A safety garment according to claim 4 wherein, the harnessing assembly is disposed at the rear of the vest.

6. A safety garment according to claim 5 wherein the buoyancy apparatus is disposed at the rear of the vest.

7. A safety garment according to claim 6 wherein the vest includes fastening tabs to secure the vest to a users torso.

8. A safety garment according to claim 7 further comprising leg straps which fasten the safety garment to the legs of a wearer.

9. A safety garment according to claim 8 wherein, the leg straps are fastened to the waste region of the vest via connecting straps.

10. A safety garment according to claim 9 wherein, the internal space in which the weights are retained is disposed on the front of the garment.

11. A safety garment according to claim 10 wherein the buoyancy apparatus includes means to allow a wearer to select a required amount of buoyancy;

12. A safety garment according to claim 11 wherein the vest is manufactured from a plastics material.

13. A safety garment comprising a combined safety harness, buoyancy apparatus and weighting assembly, the garment comprising;
a garment body arranged for location on a torso of a wearer; the garment body including openings to accommodate a wearer's neck and arms;
fastening straps for securing the garment to the body of a wearer;
at least one internal pocket which receives and retains weights;
the buoyancy apparatus providing means to allow a wearer to select a required amount of buoyancy;
the safety harness adapted to allow attachment of said garment to a load line thereby allowing the garment to support the weight of a person wearing the garment.

14 A vest comprising a combined safety harness, buoyancy apparatus and weighting means to collectively form a safety garment, the garment comprising;
a garment body arranged for location on a torso of a wearer; the garment body including openings to accommodate a wearers neck and arms;
means for securing the garment to the body of a wearer;
an internal space which receives and retains weights therein;
the buoyancy apparatus having means to allow a wearer to select a required amount of buoyancy;
the safety harness adapted to allow attachment of said garment to a load line; the harnessing assembly allowing the garment to support the weight of a person wearing the garment.

15. A vest comprising a combined safety harness, buoyancy apparatus and weighting pockets to form a safety garment, the garment comprising;
a garment body arranged for location on a torso of a wearer; the garment body including openings to accommodate a wearers neck and arms;
means for securing the garment to the body of a wearer;
at least one internal space disposed about the girth of a wearer which forms said weighting pockets and receives and retains weights therein;
the buoyancy apparatus disposed at a rear of the safety garment and providing means to allow a wearer to select a required amount of buoyancy;
the safety harness adapted to allow attachment of said garment to a load line via attachment means disposed near a shoulder region of the garment; the harnessing assembly allowing the garment to support the weight of a person wearing the garment.
